(19) United States
(12) Patent Application Publication
(10) Pub. No.: US 2026/0333081 A1
(43) Pub. Date: Oct. 22, 2026

(54) METHODS AND SYSTEM FOR RESOURCE REDIRECTION FOR CHANNEL GRANT SUSPENSION

(71) Applicant: Charter Communications Operating, LLC, St. Louis, MO (US)

(72) Inventors: Pareshkumar Panchal, Highlands Ranch, CO (US); Lakhbir Singh, Aurora, CO (US)

(73) Assignee: Charter Communications Operating, LLC, St. Louis, MO (US)

(21) Appl. No.: 19/185,535

(22) Filed: Apr. 22, 2025

(51) Int. Cl. H04W 24/04; H04W 24/02; H04W 24/10; H04W 72/51

(52) U.S. Cl. CPC H04W 24/04; H04W 24/02; H04W 24/10; H04W 72/51

(57) ABSTRACT

Systems and methods which maintain active communications sessions in the event of channel grant suspensions. A method includes reviewing available radio resources at the base station for an impacted user device due to a Citizens Broadband Radio Service (CBRS) channel suspension, receiving, by a network optimizer from the base station, neighbor base station measurement reports and radio resource requirements for the impacted user device, determining a neighbor base station which can allocate radio resources for the impacted user device based on the neighbor base station measurement reports, the radio resource requirements, and a neighbor base station capacity, initiating, by the base station, a radio resource redirection of the impacted user device to the neighbor base station in response to a message from the network optimizer; and allocating, by the neighbor base station, radio resources to the impacted user device while maintaining active communications sessions.

### TECHNICAL FIELD

This disclosure relates to communications. More specifically, maintenance of active communications sessions in the event of channel grant suspension.

### BACKGROUND

Wireless network operators or service providers can operate with or use multiple carriers to provide coverage and capacity for communications between devices. These multiple carriers can use licensed radio frequency spectrum for third generation (3G), fourth generation (4G), and fifth generation (5G) wireless communications, and unlicensed spectrum. Citizens Broadband Radio Service (CBRS) spectrum is a type of unlicensed spectrum or shared radio frequency spectrum which is shared between multiple entities including government users (such as the military), licensed users, and non-licensed users. CBRS is a multitiered wireless band between 3550 MHz and 3700 MHz. In particular, CBRS is a three-tiered access framework including incumbent users (i.e., federal, military, and the like), priority access users (winning auction bidders) who have Priority Access Licenses (PALs) to CBRS spectrum, and general authorized access (GAA) users, where the general users are permitted to use any portion of the CBRS spectrum not assigned to a higher tier user and may also operate opportunistically on unused priority access spectrum. Availability of CBRS spectrum dynamically changes depending on use by higher priority entities. Higher tier users are protected from lower tier users using a centralized spectrum access system (SAS), which may be a federal or commercial entity. The SAS authorizes or grants spectrum to access points known as CBRS Devices (CBSDs) and performs interference management to protect higher tier users. This protection may include, for example, dropping CBSDs which are general authorized access users. In summary, CBRS is an interference limited network which means that the performance of the network and the data sent to CBRS subscribers is limited by the amount of interference the CBRS users or subscribers experience in the frequency band of operation.

As noted above, CBRS is a 150 MHz band between 3550 MHz and 3700 MHz. This 150 MHz band is typically divided into 15 channels, where each channel has a bandwidth of 10 MHz. The SAS can grant a number of channels for use by CBSDs, which in turn are accessed by mobile devices. The SAS can then issue a channel grant suspension for some or all of the channels granted to one or more of the CBSDs. The CBSDs will then have to terminate the operations in the suspended channel(s). If the number of channels is reduced, then mobile devices operating or using the now suspended channels may have interrupted, affected, or compromised services.

### SUMMARY

Disclosed is a system and methods for maintaining active communications sessions in the event of channel grant suspensions or providing resource redirection for channel grant suspensions. In implementations, the method includes reviewing, by a base station, available radio resources at the base station for an impacted user device, where the impacted user device is a user device which has an active communications session with the base station that is impacted by a Citizens Broadband Radio Service (CBRS) channel grant suspension, receiving, by a network optimizer from the base station, neighbor base station measurement reports and radio resource requirements for the impacted user device when the base station lacks radio resources to support the impacted user device, determining, by the network optimizer, a neighbor base station which can allocate radio resources for the impacted user device based on the neighbor base station measurement reports, the radio resource requirements, and a neighbor base station capacity, initiating, by the base station, a radio resource redirection of the impacted user device to the neighbor base station in response to a message from the network optimizer; and allocating, by the neighbor base station, radio resources to the impacted user device, where the active communications session is maintained for the impacted user device.

### BRIEF DESCRIPTION OF THE DRAWINGS

The disclosure is best understood from the following detailed description when read in conjunction with the accompanying drawings. It is emphasized that, according to common practice, the various features of the drawings are not to scale. On the contrary, the dimensions of the various features are arbitrarily expanded or reduced for clarity.

FIG. 1 is a diagram of an example of a system in accordance with the teachings described herein.

FIG. 2 is a flowchart of an example method for maintaining services continuity in accordance with the teachings described herein.

FIG. 3 is a diagram of an example of a system in accordance with the teachings described herein.

FIG. 4 is a flow diagram of an example services continuity flow with no reallocation in target base station in accordance with the teachings described herein.

FIG. 5 is an example of target base station channel allocation for the example of FIG. 4 in accordance with the teachings described herein.

FIG. 6 is a flow diagram of an example services continuity flow with reallocation in target base station in accordance with the teachings described herein.

FIG. 7 is an example of target base station channel reallocation for the example of FIG. 6 in accordance with the teachings described herein.

FIGS. 8A and 8B are examples of target base station channel reallocation for the example of FIG. 6 in accordance with the teachings described herein.

FIG. 9 is a block diagram of an example of a device in accordance with the teachings described herein.

### DETAILED DESCRIPTION

Reference will now be made in greater detail to embodiments, examples of which are illustrated in the accompanying drawings. Wherever possible, the same reference numerals will be used throughout the drawings and the description to refer to the same or like parts.

As used herein, the terminology “server”, “computer”, “computing device or platform”, or “cloud computing system” includes any unit, or combination of units, capable of performing any method, or any portion or portions thereof, disclosed herein. For example, the “server”, “computer”, “computing device or platform”, or “cloud computing system” may include at least one or more processor(s).

As used herein, the terminology “processor” or “processing circuitry” indicates one or more processors, such as one or more special purpose processors, one or more digital signal processors, one or more microprocessors, one or more controllers, one or more microcontrollers, one or more application processors, one or more central processing units (CPU)s, one or more graphics processing units (GPU)s, one or more digital signal processors (DSP)s, one or more application specific integrated circuits (ASIC)s, one or more application specific standard products, one or more field programmable gate arrays, any other type or combination of integrated circuits, one or more state machines, or any combination thereof.

As used herein, the term “engine” may include software, hardware, or a combination of software and hardware. An engine may be implemented using software stored in the memory subsystem. Alternatively, an engine may be hard-wired into processing circuitry. In some cases, an engine includes a combination of software stored in the memory and hardware that is hard-wired into the processing circuitry.

As used herein, the terminology “memory” indicates any computer-usable or computer-readable medium or device that can tangibly contain, store, communicate, or transport any signal or information that may be used by or in connection with any processor. For example, a memory may be one or more read-only memories (ROM), one or more random access memories (RAM), one or more registers, low power double data rate (LPDDR) memories, one or more cache memories, one or more semiconductor memory devices, one or more magnetic media, one or more optical media, one or more magneto-optical media, or any combination thereof.

As used herein, the term “memory” includes one or more memories, where each memory may be a computer-readable medium. A memory may encompass memory hardware units (e.g., a hard drive or a disk) that store data or instructions in software form. Alternatively or in addition, the memory may include data or instructions that are hard-wired into processing circuitry. The memory may include a single memory unit or multiple joint or disjoint memory units, which each of the multiple joint or disjoint memory units storing all or a portion of the data described as being stored in the memory.

As used herein, the terminology “instructions” may include directions or expressions for performing any method, or any portion or portions thereof, disclosed herein, and may be realized in hardware, software, or any combination thereof. For example, instructions may be implemented as information, such as a computer program, stored in memory that may be executed by a processor to perform any of the respective methods, algorithms, aspects, or combinations thereof, as described herein. For example, the memory can be non-transitory. Instructions, or a portion thereof, may be implemented as a special purpose processor, or circuitry, that may include specialized hardware for carrying out any of the methods, algorithms, aspects, or combinations thereof, as described herein. In some implementations, portions of the instructions may be distributed across multiple processors on a single device, on multiple devices, which may communicate directly or across a network such as a local area network, a wide area network, the Internet, or a combination thereof.

As used herein, the term “application” refers generally to a unit of executable software that implements or performs one or more functions, tasks, or activities. For example, applications may perform one or more functions including, but not limited to, telephony, web browsers, e-commerce transactions, media players, scheduling, management, smart home management, entertainment, and the like. The unit of executable software generally runs in a predetermined environment and/or a processor.

As used herein, the terminology “determine” and “identify,” or any variations thereof includes selecting, ascertaining, computing, looking up, receiving, determining, establishing, obtaining, or otherwise identifying or determining in any manner whatsoever using one or more of the devices and methods are shown and described herein.

As used herein, the terminology “example,” “the embodiment,” “implementation,” “aspect,” “feature,” or “element” indicates serving as an example, instance, or illustration. Unless expressly indicated, any example, embodiment, implementation, aspect, feature, or element is independent of each other example, embodiment, implementation, aspect, feature, or element and may be used in combination with any other example, embodiment, implementation, aspect, feature, or element.

As used herein, the terminology “or” is intended to mean an inclusive “or” rather than an exclusive “or.” That is, unless specified otherwise, or clear from context, “X includes A or B” is intended to indicate any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from the context to be directed to a singular form.

As used herein, unless explicitly stated otherwise, any term specified in the singular may include its plural version. For example, “a computer that stores data and runs software,” may include a single computer that stores data and runs software or two computers-a first computer that stores data and a second computer that runs software. Also “a computer that stores data and runs software,” may include multiple computers that together stored data and run software. At least one of the multiple computers stores data, and at least one of the multiple computers runs software.

Further, for simplicity of explanation, although the figures and descriptions herein may include sequences or series of steps or stages, elements of the methods disclosed herein may occur in various orders or concurrently. Additionally, elements of the methods disclosed herein may occur with other elements not explicitly presented and described herein. Furthermore, not all elements of the methods described herein may be required to implement a method in accordance with this disclosure and claims. Although aspects, features, and elements are described herein in particular combinations, each aspect, feature, or element may be used independently or in various combinations with or without other aspects, features, and elements.

Further, the figures and descriptions provided herein may be simplified to illustrate aspects of the described teachings and/or embodiments that are relevant for a clear understanding of the herein disclosed processes, machines, and/or manufactures, while eliminating for the purpose of clarity other aspects that may be found in typical similar devices, systems, and methods. Those of ordinary skill may thus recognize that other elements and/or steps may be desirable or necessary to implement the devices, systems, and methods described herein. However, because such elements and steps do not facilitate a better understanding of the disclosed teachings and/or embodiments, a discussion of such elements and steps may not be provided herein. However, the present disclosure is deemed to inherently include all such elements, variations, and modifications to the described aspects that would be known to those of ordinary skill in the pertinent art in light of the discussion herein.

Described herein is a device and method for maintaining services continuity in the event of a spectrum access system (SAS) channel grant suspension. In implementations, the system and methods described herein can use handover, channel redirection, radio resource redirection, user device redirection, or user redirection (collectively may be referred to as “radio resource redirection”) at the time of channel grant suspension at a base station (a source base station) to maintain session continuity. The radio resource redirection process can happen and complete before termination of operations on the suspended channel or frequency channel (collectively “channel”), where the suspended channel is CBRS spectrum or a CBRS channel (collectively “CBRS channel”).

In implementations, the radio resource redirection process can use the same and/or different radio resources at a neighbor or target base station without having to intervene with current or existing users'radio resources allocation at the neighbor base station. That is, the radio resources at a neighbor or target base station can be, but is not limited, to CBRS spectrum, unlicensed spectrum, shared spectrum, licensed spectrum, and/or combinations thereof. In implementations, radio resources can further refer to different radio resource levels including, but not limited to, channels, physical resource blocks (PRB(s)), resource elements (RE(s)), and/or combinations thereof.

In implementations, the radio resource redirection process can use the same and/or different radio resources at a neighbor or target base station by reallocating the radio resources allocated to current or existing user devices users to accommodate the new user devices from the source base station at the neighbor base station.

In implementations, the source base station can review or evaluate user devices accessing, using, or operating in the suspended channel. The source base station may account for priorities associated with the user devices, where priorities refers to the user service profile or quality of service on which current resource allocation is based. The source base station can schedule all user devices operating under the suspended channel to available radio resources before terminating the suspended bandwidth or channel. In one option, the user devices can be supported using radio resources at a neighbor base station while maintaining user experience and/or user perceived quality for the existing user devices and any new users (with similar or more resource block allocation) connecting to the neighbor base station. The new users or user devices being the users or user devices from the source base station and the allocation being based on the respective priorities. In this instance, radio resources for the existing user devices are not modified, changed, altered, and/or reallocated (collectively “reallocated”). In another option, the new user devices can be supported by reallocating radio resources being used by existing user devices at the neighbor base station while maintaining connectivity and user experience. In both options, the new users or user devices being the users or user devices from the source base station and the allocation being based on the respective priorities.

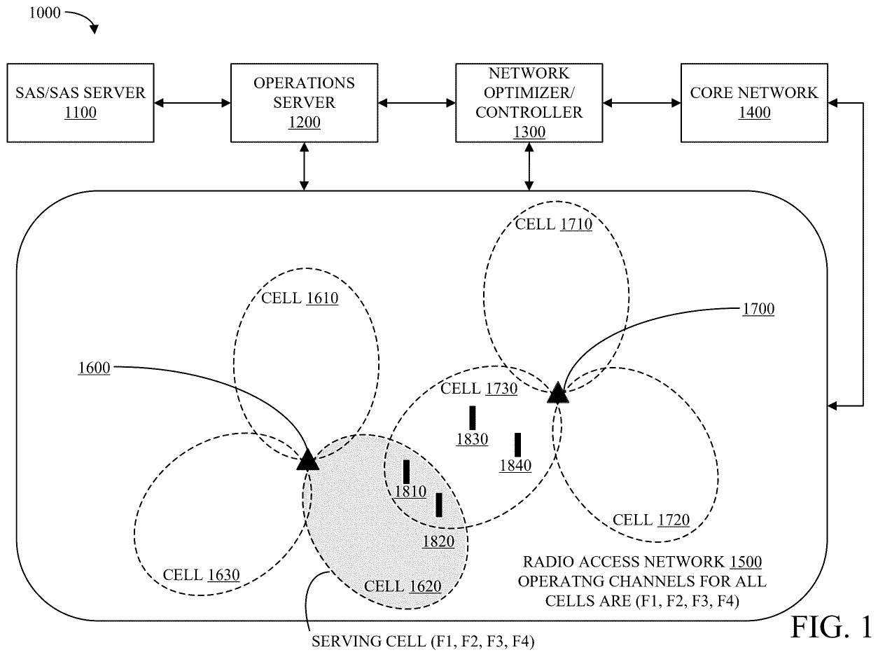

FIG. 1 is a diagram of an example of a system 1000 in accordance with the teachings described herein. The system 1000 can include, but is not limited to, a SAS 1100, an operations support system (OSS) 1200, a network optimizer 1300, a core network 1400, and a radio access network (RAN) 1500. In implementations, the RAN 1500 can include, but is not limited to, base stations 1600 and 1700. The system 1000 can implement any wireless technology including, but not limited to, third generation (3G), fourth generation (4G), and fifth generation (5G) wireless communications and/or networks, and CBRS or shared spectrum wireless technologies and/or networks. The number of components shown herein are illustrative and there may be more or less in the system 1000. The system 1000 and the components therein may include other elements which may be desirable or necessary to implement the devices, systems, and methods described herein. However, because such elements and steps do not facilitate a better understanding of the disclosed teachings and/or embodiments, a discussion of such elements and steps may not be provided herein.

In implementations, the SAS 1100 can enable access to the CBRS spectrum and dynamically manages the spectrum for optimal use, efficiency, and compliance with CBRS rules. The SAS 1100 can communicate with each base station, such as the base stations 1600 and 1700, which supports CBRS for registration, grant allocation/deallocation, and interference management. The SAS 1100 can perform interference analysis based on the power measurements received from mobile device(s) and make allocation and deallocation decisions based on the interference. The SAS 1100 may be operated by a commercial, federal entity, or some combinations thereof. The SAS 1100 can be connected to the internet to provision the CBRS rules, for example.

In implementations, the OSS 1200 can provide data, statistics, and/or related information with respect to base stations, traffic, and/or other components in the system 1000. The OSS 1200 can work with the network optimizer 1300 to enable services continuity when the SAS 1100 suspends one or more CBRS channels at a base station that supports CBRS spectrum. The OSS 1200 can receive CBRS grants and suspensions from the SAS 1100 for communication to the base stations 1600 and 1700. The OSS 1200 can transmit CBRS channel terminations to the SAS 1100 based on communications received from the base stations 1600 and 1700.

In implementations, the network optimizer 1300, which can be a controller, an engine, and/or server, can receive measurement reports from a source base station (i.e., a base station at which the SAS 1100 has suspended one or more CBRS channels). The measurement reports can be from user devices at the source base station. The measurement reports can indicate, a power level of reference signals transmitted by a base station with respect to a user device. That is, the measurement reports indicate which base stations, from a power perspective, can be used to provide services continuity for the user device. Other metrics can be included in the measurement report or used to indicate the signal strength of the base station. The network optimizer 1300 can determine and make channel capacity reviews of the base stations indicated by the measurement reports. Based on the measurement reports and the channel capacity reviews, the network optimizer 1300 can trigger a handover for the user devices affected by the CBRS channel suspension.

In implementations, the core network 1400 can include various functional components to address mobility management, authentication, session management, and other related functions with respect to, for example, the base station 1600 and the base station 1700.

In implementations, the RAN 1500 can enable communication between user devices and the core network 1400 using, but not limited to, the base station 1600 and the base station 1700.

In implementations, each of the base stations 1600 and 1700 can support wireless communications via one or more of the 3G, the 4G, and the 5G wireless technologies and/or networks and via CBRS wireless technologies and/or networks, where the SAS 1100 has granted or authorized one or more CBRS channel(s). The base stations 1600 and 1700 can be, but is not limited to, a CBRS device (a CBSD), an access point, an access node, a gNodeB, a small cell base stations, a low-powered cellular radio access node, a small, low-power base station, and/or like device which enables radio communications access between a user device and other devices in wireless coverage areas or cells associated with the one or more base stations 1600 and 1700. In implementations, the base station 1600 can include, but is not limited to, a cell (wireless coverage area) 1610, a cell 1620, and a cell 1630. In implementations, the base station 1700 can include, but is not limited to, a cell 1710, a cell 1720, and a cell 1730. In implementations, the one or more of the cells 1610, 1620, and/or 1630 can overlap with the one or more of the cells 1710, 1720, and/or 1730.

In implementations, user devices 1810, 1820, 1830, and 1840 can be, but is not limited to, a mobile device, stationary wireless capable and/or Wi-Fi devices and/or clients, end user devices, Internet Protocol (IP) devices, mobile computers, laptops, handheld computers, personal media devices, smartphones, notebooks, notepads, and/or the like, all of which can operate wirelessly with the one or more of the base stations 1600 and 1700. In implementations, cell 1620 may be a serving cell for the user devices 1810 and 1820 and may operate on channels F1, F2, F3, and/or F4.

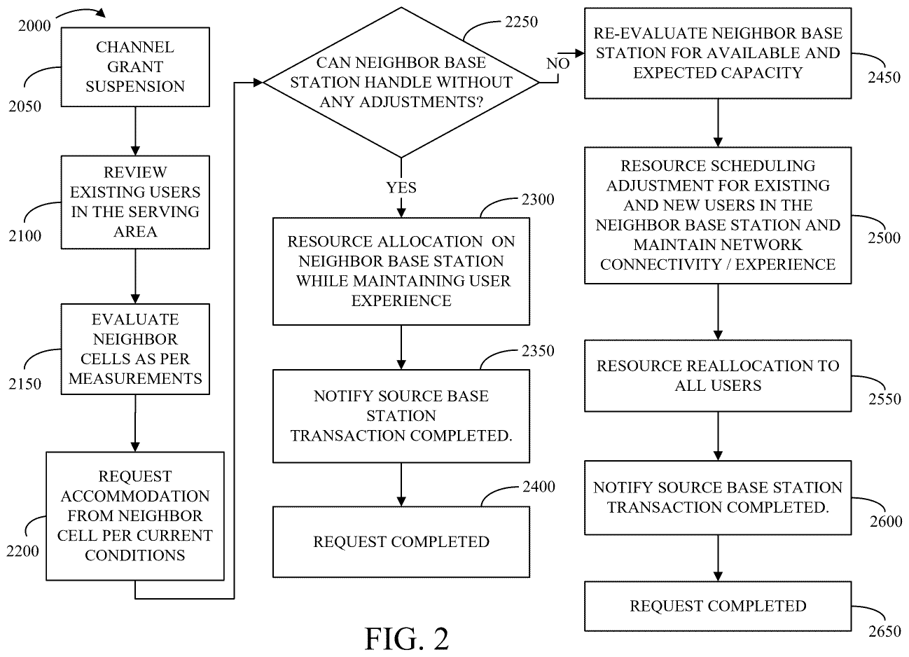

FIG. 2 is a flowchart of an example method 2000 for maintaining services continuity in accordance with the teachings described herein. In implementations, the system 1000 and components therein can use the method 2000 to maintain services continuity when a CBRS channel is suspended.

At 2050, the OSS 1200 can receive a channel grant suspension order or command from the SAS 1100. The OSS 1200 can inform an impacted base station(s), such as the base station 1600, of the channel grant suspension order. The impacted base station may have a defined interval of time in which to terminate operations on the suspended channel. In implementations, the suspended channel is a CBRS channel, an unlicensed channel, or a shared channel.

At 2100, the impacted base station can review the impacted user devices. In implementations, the impacted base station can review whether other radio resources at the impacted base station can be used to provide services to the impacted user devices. In a non-limiting illustration, the radio resources can include, but is not limited to, CBRS channels, unlicensed channels, shared channels, licensed channels, and/or combinations thereof. In a non-limiting illustration, the radio resources can be at different levels, such as, channels, PRB(s), RE(s), and/or combinations thereof. In the event that the impacted base station does not have sufficient radio resources for providing the services of the impacted user devices, at 2150, the impacted base station can make measurements with neighbor base stations to determine signal strength and other characteristics. A measurement report can be generated based on the neighbor base station measurements. The measurement report can be sent to the network optimizer. The impacted base station can also send the channel capacity requirements for the impacted user devices.

At 2200, the network optimizer can determine or evaluate which of the neighbor base station(s) has wireless coverage for the user device(s) based on at least a strength of the wireless coverage. The network optimizer can request a neighbor base station(s) to provide channel capacity, number of end users, channel conditions, channel frequencies, and other operational information (collectively “neighbor base station capacity”). The network optimizer can review the neighbor base station capacity(ies), the channel capacity requirements (i.e., the respective priorities for each impacted user device) for the impacted user devices, and request one or more neighbor base station(s) to accommodate one or more of the impacted user devices. That is, the network optimizer can initiate a handover process to neighbor base station(s). A handover command can be sent to the neighbor base station(s).

At 2250, a neighbor base station(s) can determine whether impacted user device(s) can be added without adjusting currently deployed radio resources. If yes, at 2300, the neighbor base station can allocate radio resources to impacted user device(s) while maintaining user experience and connectivity (i.e., active communications sessions) for the impacted user device(s) and the users currently being serviced by the neighbor base station(s). At 2350, the neighbor base station(s) can notify the impacted base station (also a source base station) that the handover process is complete. At 2400, the impacted base station(s) can release the suspended channel(s). The SAS can be informed by the OSS accordingly.

If no, at 2450, the neighbor base station(s) can re-evaluate available and expected channel capacity in view of the handover command. At 2500, a resource scheduler can adjust radio resources (including, but is not limited to, CBRS channels, unlicensed channels, shared channels, licensed channels, and/or combinations thereof and at different levels, such as, channels, PRB(s), RE(s), and/or combinations thereof) for impacted user device(s) and for users currently being serviced by the neighbor base station(s) while maintaining user experience and connectivity for the impacted user device(s) and the users currently being serviced by the neighbor base station(s). At 2550, the neighbor base station(s) can allocate the adjusted radio resources to all user devices. At 2600, the neighbor base station(s) can notify the impacted base station (also a source base station) that the handover process is complete. At 2650, the impacted base station(s) can release the suspended channel(s). The SAS can be informed by the OSS accordingly.

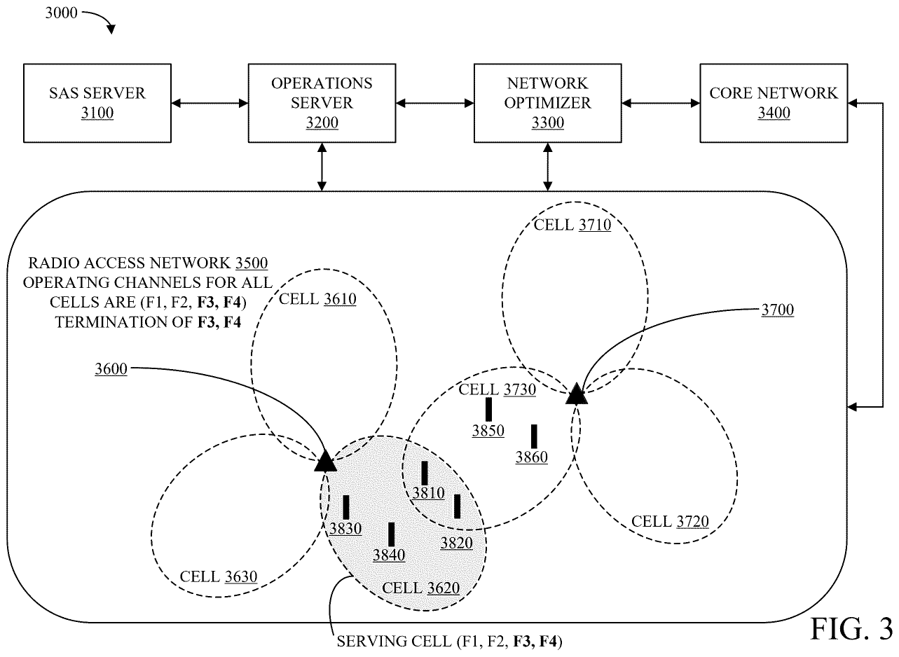

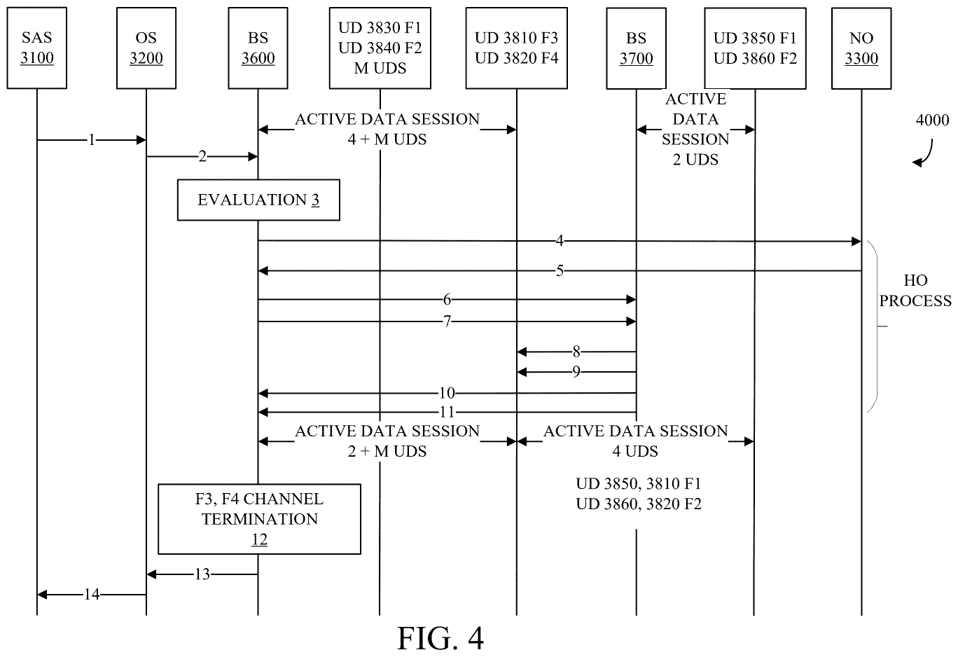

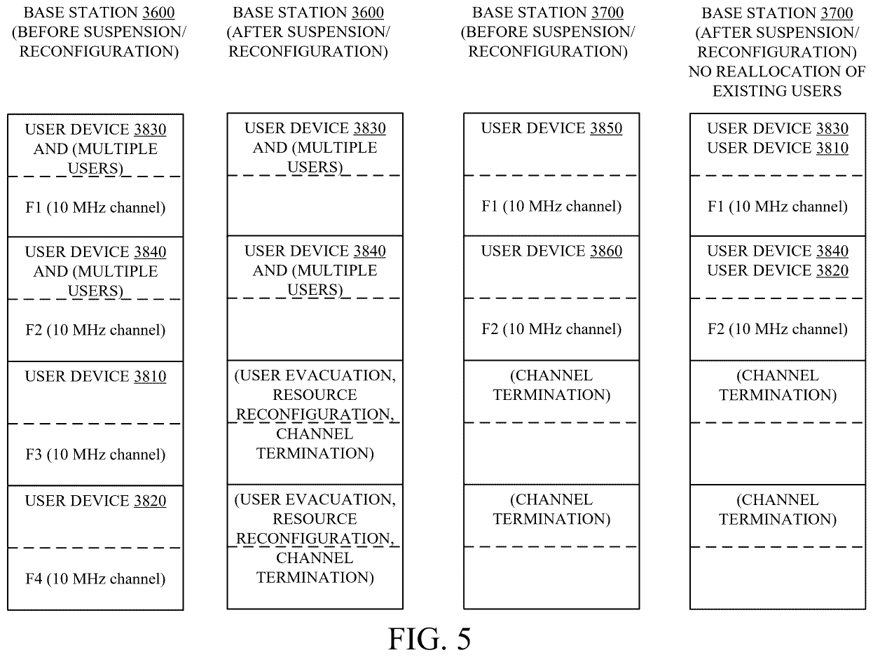

FIG. 3 is a diagram of an example of a system 3000 in accordance with the teachings described herein. Reference is also made to FIG. 4, which is a flow diagram of an example services continuity flow 4000 with no reallocation in target base station in accordance with the teachings described herein. Reference is now also made to FIG. 5, which is an example of target base station channel allocation for the services continuity flow 4000 of FIG. 4 in accordance with the teachings described herein.

The system 3000 can include, but is not limited to, a SAS 3100, an OSS 3200, a network optimizer 3300, a core network 3400, and a RAN 3500. In implementations, the RAN 3500 can include, but is not limited to, base stations 3600 and 3700. The base station 3600 can include, but is not limited to, a cell (wireless coverage area) 3610, a cell 3620, and a cell 3630. The base station 3700 can include, but is not limited to, a cell (wireless coverage area) 3710, a cell 3720, and a cell 3730. In implementations, the one or more of the cells 3610, 3620, and/or 3630 can overlap with the one or more of the cells 3710, 3720, and/or 3730. User devices 3810, 3820, 3830, 3840, 3850, and 3860 can operate in respective cells of the base stations 3600 and 3700. In implementations, cell 3620 may be a serving cell for the user devices 3810, 3820, 3830, and 3840 and may operate on channels F1, F2, F3, and/or F4. In implementations, the system 3000 and the services continuity flow 4000 can function and operate as described herein and with respect to FIGS. 1 and 2. The system 3000 can implement any wireless technology including, but not limited to, third generation (3G), fourth generation (4G), and fifth generation (5G) wireless communications and/or networks, and CBRS or shared spectrum wireless technologies and/or networks. The number of components shown herein are illustrative and there may be more or less in the system 3000. The system 3000 and the components therein may include other elements which may be desirable or necessary to implement the devices, systems, and methods described herein. However, because such elements and steps do not facilitate a better understanding of the disclosed teachings and/or embodiments, a discussion of such elements and steps may not be provided herein.

The services continuity flow 4000 can be performed by the SAS 3100, the OSS 3200, the base station 3600 (impacted or source base station), the user devices 3830 and 3840 and multiple user devices, the user devices 3810 and 3820, the base station 3700 (neighbor or target base station), the user devices 3850 and 3860, and the network optimizer 3300.

Initially, the base station 3600 can have multiple active data sessions, including but not limited to, active data sessions with the user devices 3810, 3820, 3830, 3840, and multiple user devices. The user devices 3830 and 3840 use channels F1 and F2. The user devices 3810 and 3820 use channels F3 and F4. The base station 3700 can have multiple active data sessions, including but not limited to, active data sessions with the user devices 3850 and 3860. The user devices 3850 and 3860 use channels F1 and F2. In this instance, channels F3 and F4 are CBRS channels. This is illustrated in FIG. 5.

At (1), the SAS 3100 can send a channel grant suspension for channels F3 and F4 to the OSS 3200. At (2), the OSS 3200 can notify the base station 3600 of the channel grant suspension. As a result, the base station 3600 now operates on channels F1 and F2. At (3), the base station 3600 can evaluate available radio resources and user devices in view of the channel grant suspension. If radio resources are available at the base station 3600, the base station 3600 can allocate and/or re-allocate the radio resources as appropriate. If there are no available radio resources at the base station 3600, then at (4), the base station 3600 can send measurement report(s) for neighbor base station(s), channel capacity requirements for the impacted user devices, and a request for a channel capacity review to the network optimizer 3300.

At (5), the network optimizer 3300 can review the measurement report(s) for neighbor base station(s) and request a neighbor base station capacity from one or more neighbor base station(s). The network optimizer 3300 can review the measurement report(s) for neighbor base station(s), the channel capacity requirements for the impacted user devices, and the neighbor base station capacity(ies). The network optimizer 3300 can send a handover message to the base station 3600 based on the review. The handover message can indicate which user devices are to be handed over to which neighbor base station(s). In the non-limiting illustration, user devices 3830 and 3840 are to be handed off to the base station 3700.

At (6), the base station 3600 can send a handover message/command to the base station 3700 to allocate radio resources to the user device 3830 while maintaining user experience and connectivity for the user device 3830 and the user devices 3850 and 3860. At (7), the base station 3600 can send a handover message/command to the base station 3700 to allocate radio resources to the user device 3840 while maintaining user experience and connectivity for the user device 3840 and the user devices 3850 and 3860.

At (8), the base station 3700 can allocate radio resources to user device 3810. In the non-limiting illustration, the base station 3700 can allocate channel F1 to the user device 3810. At (9), the base station 3700 can allocate radio resources to user device 3820. In the non-limiting illustration, the base station 3700 can allocate channel F2 to the user device 3820. At (10), the base station 3700 can send an acknowledgement of the handover message/command and a radio resource release message to the base station 3600 upon completion of the handover for user device 3810. At (11), the base station 3700 can send an acknowledgement of the handover message/command and a radio resource release message to the base station 3600 upon completion of the handover for user device 3820. As a result, the base station 3600 now has active data sessions for user devices 3830 and 3840 and multiple user devices on channels F3 and F4, as appropriate. The base station 3700 now has active data sessions for user devices 3850, 3860, 3810, and 3820 on channels F1 and F2, as appropriate. This is shown in FIG. 5.

At (12), the base station 3600 can release or terminate operations in response to the release message from the base station 3700. At (13), the base station 3600 can send an acknowledgement message to the OSS 3200 that the suspended channels have been released. At (14), the OSS 3200 can send an acknowledgement message to the SAS 3100 that the suspended channels have been released.

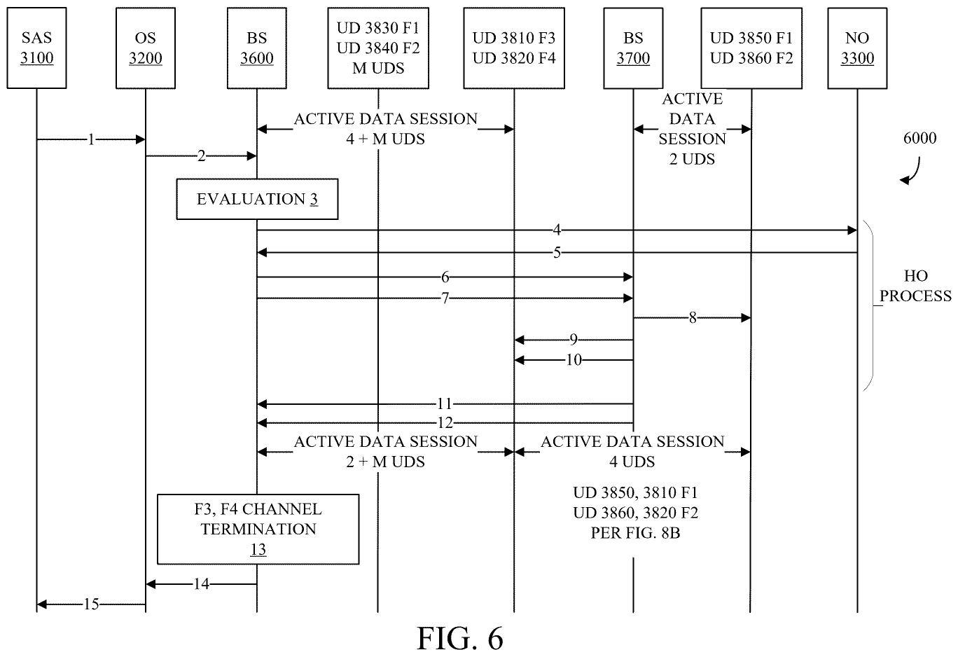

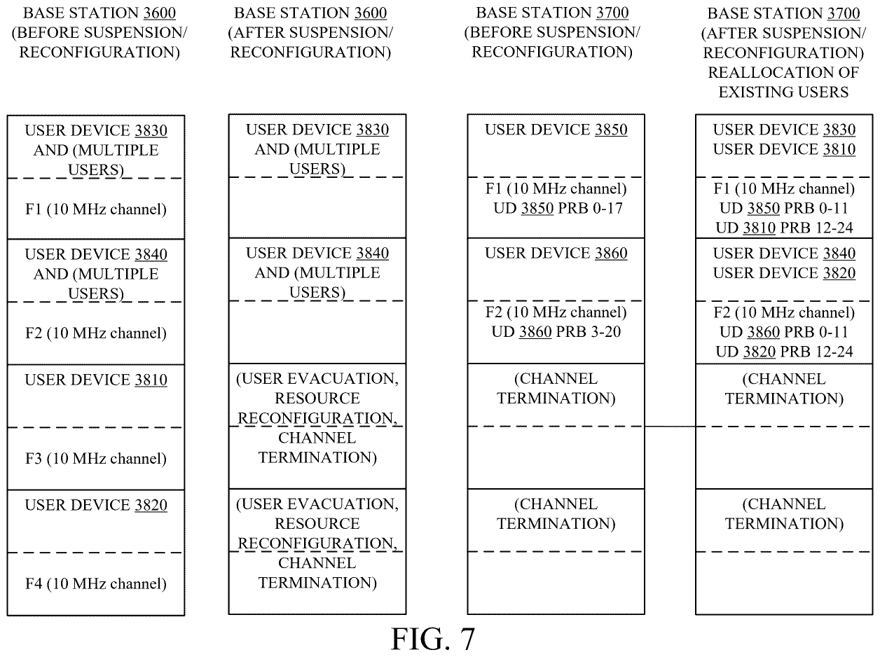

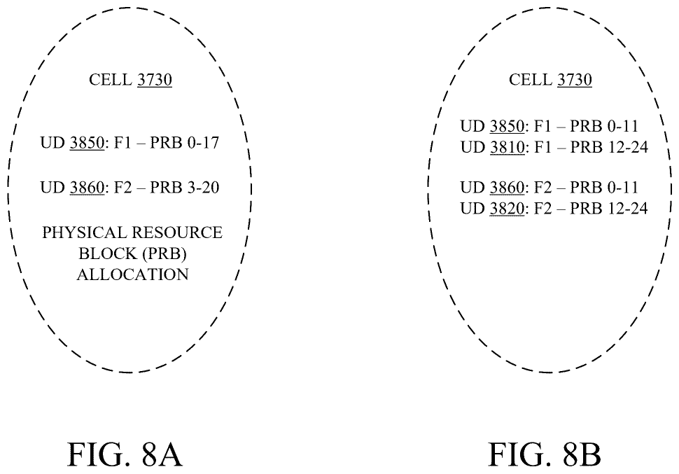

Referring back to FIG. 3 and now also referring to FIG. 6, which is a flow diagram of an example services continuity flow 6000 with reallocation in target base station in accordance with the teachings described herein, FIG. 7, which is an example of target base station channel reallocation for the services continuity flow 6000 of FIG. 6 in accordance with the teachings described herein, and FIGS. 8A and 8B, which are examples of target base station channel reallocation for the services continuity flow 6000 of FIG. 6 in accordance with the teachings described herein.

The services continuity flow 4000 can be performed by the SAS 3100, the OSS 3200, the base station 3600 (impacted or source base station), the user devices 3830 and 3840 and multiple user devices, the user devices 3810 and 3820, the base station 3700 (neighbor or target base station), the user devices 3850 and 3860, and the network optimizer 3300.

Initially, the base station 3600 can have multiple active data sessions, including but not limited to, active data sessions with the user devices 3810, 3820, 3830, 3840, and multiple user devices. The user devices 3830 and 3840 use channels F1 and F2. The user devices 3810 and 3820 use channels F3 and F4. The base station 3700 can have multiple active data sessions, including but not limited to, active data sessions with the user devices 3850 and 3860. The user device 3850 uses PRBs 0-17 of channel F1 and the user device 3860 uses PRBs 3-20 of channel F2. In this instance, channels F3 and F4 are CBRS channels. This is illustrated in FIGS. 7, 8A, and 8B.

At (1), the SAS 3100 can send a channel grant suspension for channels F3 and F4 to the OSS 3200. At (2), the OSS 3200 can notify the base station 3600 of the channel grant suspension. As a result, the base station 3600 now operates on channels F1 and F2. At (3), the base station 3600 can evaluate available radio resources and user devices in view of the channel grant suspension. If radio resources are available at the base station 3600, the base station 3600 can allocate and/or re-allocate the radio resources as appropriate. If there are no available radio resources at the base station 3600, then at (4), the base station 3600 can send measurement report(s) for neighbor base station(s), channel capacity requirements for the impacted user devices, and a request for a channel capacity review to the network optimizer 3300.

At (5), the network optimizer 3300 can review the measurement report(s) for neighbor base station(s) and request a neighbor base station capacity from one or more neighbor base station(s). The network optimizer 3300 can review the measurement report(s) for neighbor base station(s), the channel capacity requirements for the impacted user devices, and the neighbor base station capacity(ies). The network optimizer 3300 can send a handover message to the base station 3600 based on the review. The handover message can indicate which user devices are to be handed over to which neighbor base station(s). In the non-limiting illustration, user devices 3830 and 3840 are to be handed off to the base station 3700.

At (6), the base station 3600 can send a handover message/command to the base station 3700 to allocate radio resources to the user device 3830 while maintaining user experience and connectivity for the user device 3830 and the user devices 3850 and 3860. At (7), the base station 3600 can send a handover message/command to the base station 3700 to allocate radio resources to the user device 3840 while maintaining user experience and connectivity for the user device 3840 and the user devices 3850 and 3860.

At (8), the base station 3700 can re-allocate radio resources to the user devices 3850 and 3860 to accommodate the user devices 3830 and 3840 while maintaining user experience and connectivity for the user devices 3830, 3840, 3850 and 3860. In a non-limiting illustration, the user device 3850 can be assigned PRBs 0-11 of channel F1 and the user device 3860 can be assigned PRBs 0-11 of channel F2. This can be seen in FIGS. 7, 8A, and 8B.

At (9), the base station 3700 can allocate radio resources to user device 3810. In the non-limiting illustration, the base station 3700 can allocate PRBs 12-24 of channel F1 to the user device 3810. At (10), the base station 3700 can allocate radio resources to the user device 3820. In the non-limiting illustration, the base station 3700 can allocate PRBs 12-24 of channel F2 to the user device 3820. At (11), the base station 3700 can send an acknowledgement of the handover message/command and a radio resource release message to the base station 3600 upon completion of the handover for user device 3810. At (12), the base station 3700 can send an acknowledgement of the handover message/command and a radio resource release message to the base station 3600 upon completion of the handover for user device 3820. As a result, the base station 3600 now has active data sessions for user devices 3830 and 3840 and multiple user devices on channels F3 and F4, as appropriate. The base station 3700 now has active data sessions for user devices 3850, 3860, 3810, and 3820 on channels F1 and F2, as appropriate. This is shown in FIGS. 7, 8A, and 8B.

At (13), the base station 3600 can release or terminate operations in response to the release message from the base station 3700. At (14), the base station 3600 can send an acknowledgement message to the OSS 3200 that the suspended channels have been released. At (15), the OSS 3200 can send an acknowledgement message to the SAS 3100 that the suspended channels have been released.

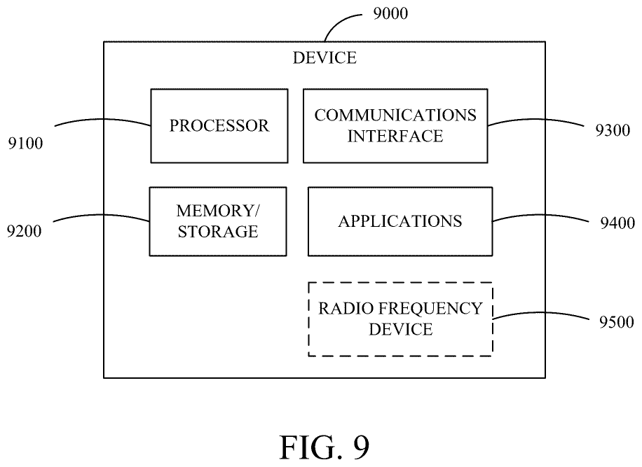

FIG. 9 is a block diagram of an example of a device 9000 in accordance with the teachings described herein. The device 9000 may include, but is not limited to, a processor 9100, a memory/storage 9200, a communications interface 9300, applications 9400, and, if needed, a radio frequency device 9500. The device 9000 may include or implement, for example, the system and components described with respect to FIGS. 1, 3, 4, and 6 and the implement the methods of FIGS. 2, 4, and 6. The applicable or appropriate flows, techniques, or methods described herein may be stored in the memory/storage 9200 and executed by the processor 9100 in cooperation with the memory/storage 9200, the communications interface 9300, the applications 9400, and the radio frequency device 9500 (when applicable), as appropriate. The device 9000 may include other elements which may be desirable or necessary to implement the devices, systems, and methods described herein. However, because such elements and steps do not facilitate a better understanding of the disclosed embodiments, a discussion of such elements and steps may not be provided herein.

Disclosed is a method for maintaining active communications sessions in the event of channel grant suspensions or providing resource redirection for channel grant suspensions. In implementations, a method includes reviewing, by a base station, available radio resources at the base station for an impacted user device, wherein the impacted user device is a user device which has an active communications session with the base station that is impacted by a Citizens Broadband Radio Service (CBRS) channel grant suspension, receiving, by a network optimizer from the base station, neighbor base station measurement reports and radio resource requirements for the impacted user device when the base station lacks radio resources to support the impacted user device, determining, by the network optimizer, a neighbor base station which can allocate radio resources for the impacted user device based on the neighbor base station measurement reports, the radio resource requirements, and a neighbor base station capacity, initiating, by the base station, a radio resource redirection of the impacted user device to the neighbor base station in response to a message from the network optimizer, and allocating, by the neighbor base station, radio resources to the impacted user device, wherein the active communications session is maintained for the impacted user device.

In implementations, the allocating further including allocating radio resources at the neighbor base station which are unused by user devices operating with the neighbor base station. In implementations, the allocating further including reallocating radio resources in use by user devices operating with the neighbor base station to the impacted user device and to the user devices operating with the neighbor base station. In implementations, the reallocating further including allocating a first set of physical resource blocks to the impacted user device, and allocating a second set of physical resource blocks to the user devices operating with the neighbor base station, where the first set of physical resource blocks and the second set of physical resource blocks are the radio resources that were in use by the user devices operating with the neighbor base station. In implementations, the radio resources reallocated to the impacted user device and the user devices operating with the neighbor base station are at least one of licensed radio resources, unlicensed radio resources, shared radio resources, or CBRS radio resources. In implementations, the method further including sending, by the base station in response to the CBRS channel grant suspension, a message that radio resources impacted by the CBRS channel grant suspension have been released. In implementations, the radio resources allocated to the impacted user device are at least one of licensed radio resources, unlicensed radio resources, shared radio resources, or CBRS radio resources. In implementations, the method further including releasing, by the base station, radio resources impacted by the CBRS channel grant suspension upon completion of the radio resource redirection. In implementations, the method further including requesting, by the network optimizer from the neighbor base station, a neighbor base station capacity.

Disclosed is a method for enabling session continuity. In implementations, the method includes receiving, by a network controller from a base station, target base station measurement reports and channel requirements for mobile devices having active sessions which are impacted by a Citizens Broadband Radio Service (CBRS) channel suspension at the base station, determining, by the network controller, which target base station has available channel capacity for the mobile devices based on the channel requirements, and assigning, by the target base station, channels to the mobile devices in response to a channel redirection from the network controller, where the active sessions and user experience are maintained for the mobile devices.

In implementations, the assigning further including assigning unused channels at the target base station. In implementations, the assigning further including reassigning channels used by target base station mobile devices to the mobile devices and to the target base station mobile devices. In implementations, the reassigning further including allocating a portion of physical resource blocks to the mobile devices and allocating another portion of the physical resource blocks to the target base station mobile devices, where the portion of the physical resource blocks and the another portion of the physical resource blocks are portions of the channels used by target base station mobile devices. In implementations, the channels reassigned to the mobile devices and the target base station mobile devices are at least one of licensed channels, shared channels, unlicensed channels, or CBRS channels. In implementations, the channels assigned to the mobile devices are at least one of licensed channels, shared channels, unlicensed channels, or CBRS channels. In implementations, the method further including releasing, by the base station, channels impacted by the CBRS channel suspension upon completion of the channel redirection. In implementations, the method further including requesting, by the network controller from the target base station, the available channel capacity.

Disclosed is a system for enabling session continuity. In implementations, the system includes a controller configured to receive target base station measurement reports and channel requirements for user devices that were impacted by an unlicensed spectrum suspension order received at a base station where the user devices have active communication sessions, and select a target base station based on the channel requirements and available target base station channel capacity, and a selected target base station configured to assign channels to the user devices that were impacted by the unlicensed spectrum suspension order in response to a redirection message from the controller, where the active communications sessions and user experience are maintained for the user devices that were impacted by the unlicensed spectrum suspension order.

In implementations, the channels assigned to the user devices that were impacted by the unlicensed spectrum suspension order are channels that were used by target base station user devices and are reassigned to the user devices that were impacted by the unlicensed spectrum suspension order and to the target base station user devices. In implementations, the channels assigned to the user devices that were impacted by the unlicensed spectrum suspension order are at least one of licensed channels, channels, shared channels, or unlicensed channels.

Although some teachings and/or embodiments herein refer to methods, it will be appreciated by one skilled in the art that they may also be embodied as a system or computer program product. Accordingly, aspects may take the form of an entirely hardware embodiment, an entirely software embodiment (including firmware, resident software, micro-code, etc.) or an embodiment combining software and hardware aspects that may all generally be referred to herein as a “processor,” “device,” or “system.” Furthermore, aspects may take the form of a computer program product embodied in one or more the computer readable mediums having the computer readable program code embodied thereon. For example, the computer readable mediums can be non-transitory. Any combination of one or more computer readable mediums may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electromagnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to CDs, DVDs, wireless, wireline, optical fiber cable, RF, etc., or any suitable combination of the foregoing.

As used herein, the term “computer-readable medium” encompasses one or more computer-readable media. A computer-readable medium may include any storage unit (or multiple storage units) that store data or instructions that are readable by processing circuitry. A computer-readable medium may include, for example, at least one of a data repository, a data storage unit, a computer memory, a hard drive, a disk, or a random access memory. A computer-readable medium may include a single computer-readable medium or multiple computer-readable media. A computer-readable medium may be a transitory computer-readable medium or a non-transitory computer-readable medium.

Computer program code for carrying out operations for aspects may be written in any combination of one or more programming languages, including an object-oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects are described herein with reference to flowchart illustrations and/or block diagrams of methods, apparatus (systems) and computer program products according to teachings and/or embodiments. It will be understood that each block of the flowchart illustrations and/or block diagrams, and combinations of blocks in the flowchart illustrations and/or block diagrams, can be implemented by computer program instructions.

These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowcharts and block diagrams in the figures illustrate the architecture, functionality, and operation of possible implementations of systems, methods, and computer program products according to various teachings and/or embodiments. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures.

While the disclosure has been described in connection with certain teachings and/or embodiments, it is to be understood that the disclosure is not to be limited to the disclosed teachings and/or embodiments but, on the contrary, is intended to cover various modifications, combinations, and equivalent arrangements included within the scope of the appended claims, which scope is to be accorded the broadest interpretation so as to encompass all such modifications and equivalent structures as is permitted under the law.

What is claimed is:

1. A method for maintaining active communications sessions for channel grant suspensions, the method comprising:
reviewing, by a base station, available radio resources at the base station for an impacted user device, wherein the impacted user device is a user device which has an active communications session with the base station that is impacted by a Citizens Broadband Radio Service (CBRS) channel grant suspension;
receiving, by a network optimizer from the base station, neighbor base station measurement reports and radio resource requirements for the impacted user device when the base station lacks radio resources to support the impacted user device;
determining, by the network optimizer, a neighbor base station which can allocate radio resources for the impacted user device based on the neighbor base station measurement reports, the radio resource requirements, and a neighbor base station capacity;
initiating, by the base station, a radio resource redirection of the impacted user device to the neighbor base station in response to a message from the network optimizer; and
allocating, by the neighbor base station, radio resources to the impacted user device,
wherein the active communications session is maintained for the impacted user device.

2. The method of claim 1, wherein the allocating further comprising:
allocating radio resources at the neighbor base station which are unused by user devices operating with the neighbor base station.

3. The method of claim 1, wherein the allocating further comprising:
reallocating radio resources in use by user devices operating with the neighbor base station to the impacted user device and to the user devices operating with the neighbor base station.

4. The method of claim 3, wherein the reallocating further comprising:
allocating a first set of physical resource blocks to the impacted user device; and
allocating a second set of physical resource blocks to the user devices operating with the neighbor base station,
wherein the first set of physical resource blocks and the second set of physical resource blocks are the radio resources that were in use by the user devices operating with the neighbor base station.

5. The method of claim 3, wherein the radio resources reallocated to the impacted user device and the user devices operating with the neighbor base station are at least one of licensed radio resources, unlicensed radio resources, shared radio resources, or CBRS radio resources.

6. The method of claim 1, further comprising:
sending, by the base station in response to the CBRS channel grant suspension, a message that radio resources impacted by the CBRS channel grant suspension have been released.

7. The method of claim 1, wherein the radio resources allocated to the impacted user device are at least one of licensed radio resources, unlicensed radio resources, shared radio resources, or CBRS radio resources.

8. The method of claim 1, further comprising:
releasing, by the base station, radio resources impacted by the CBRS channel grant suspension upon completion of the radio resource redirection.

9. The method of claim 1, further comprising:
requesting, by the network optimizer from the neighbor base station, a neighbor base station capacity.

10. A method for enabling session continuity, the method comprising:
receiving, by a network controller from a base station, target base station measurement reports and channel requirements for mobile devices having active sessions which are impacted by a Citizens Broadband Radio Service (CBRS) channel suspension at the base station;
determining, by the network controller, which target base station has available channel capacity for the mobile devices based on the channel requirements; and
assigning, by the target base station, channels to the mobile devices in response to a channel redirection from the network controller,
wherein the active sessions and user experience are maintained for the mobile devices.

11. The method of claim 10, wherein the assigning further comprising:
assigning unused channels at the target base station.

12. The method of claim 10, wherein the assigning further comprising:
reassigning channels used by target base station mobile devices to the mobile devices and to the target base station mobile devices.

13. The method of claim 12, wherein the reassigning further comprising:
allocating a portion of physical resource blocks to the mobile devices; and
allocating another portion of the physical resource blocks to the target base station mobile devices,
wherein the portion of the physical resource blocks and the another portion of the physical resource blocks are portions of the channels used by target base station mobile devices.

14. The method of claim 12, wherein the channels reassigned to the mobile devices and the target base station mobile devices are at least one of licensed channels, shared channels, unlicensed channels, or CBRS channels.

15. The method of claim 10, wherein the channels assigned to the mobile devices are at least one of licensed channels, shared channels, unlicensed channels, or CBRS channels.

16. The method of claim 10, further comprising:
releasing, by the base station, channels impacted by the CBRS channel suspension upon completion of the channel redirection.

17. The method of claim 10, further comprising:
requesting, by the network controller from the target base station, the available channel capacity.

18. A system, comprising:
a controller configured to:
receive target base station measurement reports and channel requirements for user devices that were impacted by an unlicensed spectrum suspension order received at a base station where the user devices have active communication sessions; and
select a target base station based on the channel requirements and available target base station channel capacity; and
a selected target base station configured to:
assign channels to the user devices that were impacted by the unlicensed spectrum suspension order in response to a redirection message from the controller,
wherein the active communications sessions and user experience are maintained for the user devices that were impacted by the unlicensed spectrum suspension order.

19. The system of claim 18, wherein the channels assigned to the user devices that were impacted by the unlicensed spectrum suspension order are channels that were used by target base station user devices and are reassigned to the user devices that were impacted by the unlicensed spectrum suspension order and to the target base station user devices.

20. The system of claim 18, wherein the channels assigned to the user devices that were impacted by the unlicensed spectrum suspension order are at least one of licensed channels, channels, shared channels, or unlicensed channels.
